(19) United States
(12) Patent Application Publication
(10) Pub. No.: US 2022/0411581 A1
(43) Pub. Date: Dec. 29, 2022

(54) SEMI-AROMATIC POLYAMIDE RESIN COMPOSITION AND METAL-PLATED MOLDED BODY

(71) Applicant: TOYOBO CO., LTD., Osaka (JP)

(72) Inventors: Makoto TAMATSUSHIMA, Shiga (JP); Jun YAMADA, Shiga (JP); Maki HASEBE, Shiga (JP)

(73) Assignee: TOYOBO CO., LTD., Osaka (JP)

(21) Appl. No.: 17/780,765

(22) PCT Filed: Nov. 24, 2020
(86) PCT No.: PCT/JP2020/043612

§ 371 Date: May 27, 2022

(30) Foreign Application Priority Data
Nov. 29, 2019 (JP) 2019-216782

(51) Int. Cl. C08G 69/36; C08K 3/34; C08F 210/02; C08F 210/06; C08F 210/08; C08F 222/06; C23C 18/16

(52) U.S. Cl. CPC C08G 69/36; C08K 3/34; C08F 210/02; C08F 210/06; C08F 210/08; C08F 222/06; C23C 18/1641; C08K 2201/003

(57) ABSTRACT

To provide a semi-aromatic polyamide resin composition having excellent good plating properties, low water absorption properties, and solder reflow resistance. A semi-aromatic polyamide resin composition of the present invention comprises: 10 to 200 parts by mass of an inorganic filler (B) and 2 to 30 parts by mass of a toughness improver (C) based on 100 parts by mass of a semi-aromatic polyamide (A), wherein the semi-aromatic polyamide resin (A) satisfies the following (a) and (b): (a) a melting point (Tm) measured by differential scanning calorimetry (DSC) is 280° C. or higher; and (b) an equilibrium water absorption rate at 80° C. and 95% RH is 3.5% or less.

### TECHNICAL FIELD

The present disclosure relates to a semi-aromatic polyamide resin composition having excellent good plating properties, low water absorption properties, and solder reflow resistance.

### BACKGROUND ART

Polyamide resins have been used for clothing, fibers for industrial materials, and engineering plastics and the like by taking advantage of their excellent properties and ease of melt molding. In recent years, with technical development in each field, the application of the polyamide resin is further expanded. The polyamide resin is used in various applications ranging from automobile parts around an engine to electrical and electronic parts represented by smartphones.

With the development of various techniques, the performances of electric and electronic devices and OA devices has been enhanced. The influence of electromagnetic waves generated from various constituent parts on peripheral parts or human bodies, such as use of a motor as a drive source in the automobile field is required to be suppressed.

In order to cope with these problems, studies have been made to impart electromagnetic wave shielding properties to constituent parts of various devices. Metals having excellent electromagnetic wave shielding properties or resins containing a conductive filler have been used. These methods can achieve electromagnetic wave shielding, but have problems in terms of improvement in fuel efficiency of an automobile, weight reduction of a product, and resin processability.

Meanwhile, as a method in which electromagnetic wave shielding properties are imparted to constituent parts of a device, a method in which the surface of a resin molded body is subjected to metal vapor-deposition or metal plating has been known. The method facilitates weight reduction as compared with a case where the part itself is made of a metal, and can impart sufficient electromagnetic wave shielding properties, whereby the method is used in various fields.

Various metal vapor-deposition and metal plating techniques for resins have been developed. Patent Document 1 discloses a polyamide resin composition having excellent adhesion properties to metal plating composed of a polyamide, an inorganic filler, and a modified styrene-olefin-based copolymer. However, the polyamide resin composition described in the document has a melting point lower than 280° C., which makes it difficult to withstand a solder reflow step used for producing a base part.

Patent Document 2 discloses a resin composition for metal vapor-deposition containing a polyamide resin, a styrene-based resin, and a filler. However, the resin composition for metal vapor-deposition described in the document is described to have good adhesion with a metal film formed by a metal vapor-deposition technique, and is essentially different from a metal plating technique of the present invention in the process of forming the metal film. All of the resin compositions for metal vapor-deposition described in Examples have a melting point lower than 280° C., which make it difficult to withstand the solder reflow step.

Patent Document 3 discloses a resin composition for forming a plating layer containing a semi-aromatic polyamide composed of terephthalic acid and a diamine component having an alkylene group having 4 to 25 carbon atoms, and an inorganic filler. However, in the resin composition described in the document, an effect of further improving plating adhesion provided by a toughness improver is not mentioned.

Patent Document 4 discloses a molded body including a metal layer on the surface of a molded body obtained from a polyamide resin composition composed of a polyamide resin composed of terephthalic acid and 1,9-nonanediamine and a filler. However, in the resin composition described in the document, the polyamide resin is limited.

Patent Document 5 discloses a method for forming an electroless plating layer using a resin composition obtained by mixing a filler with a semi-aromatic polyamide resin selected from polyamide 10T, polyamide 9T, polyamide 6T, polyamide 4T, or polyphthalamide. However, the technique described in the document makes it necessary to set a mold temperature to 180 to 240° C. when a substrate to be plated is molded using a resin composition, and has limitations in terms of facilities.

As described above, various inventions have been made regarding metal vapor-deposition and metal plating on the resin, but have various problems and limitations.

### PRIOR ART DOCUMENTS

### Patent Documents

Patent Document 1: JP-A-08-11782

Patent Document 2: JP-A-2006-131821

Patent Document 3: JP-B-3009707

Patent Document 4: JP-B-3400133

Patent Document 5: JP-B-6190154

### SUMMARY OF THE INVENTION

### Problems to be Solved by the Invention

The present invention has been created in view of the current statuses of the prior arts, and an object of the present invention is to provide a semi-aromatic polyamide resin composition having excellent good plating properties, low water absorption properties, and solder reflow resistance.

In order to achieve the above object, the present inventors have intensively studied the types and blending amounts of a filler and toughness improver in addition to the composition of a semi-aromatic polyamide resin, and as a result, has provided a semi-aromatic polyamide resin composition having excellent good plating properties, low water absorption properties, and solder reflow resistance.

That is, the invention has the following structure.
(1) A semi-aromatic polyamide resin composition comprising: 10 to 200 parts by mass of an inorganic filler (B) and 2 to 30 parts by mass of a toughness improver (C) based on 100 parts by mass of a semi-aromatic polyamide (A), wherein the semi-aromatic polyamide resin (A) satisfies the following (a) and (b):
(a) a melting point (Tm) measured by differential scanning calorimetry (DSC) is 280° C. or higher; and
(b) an equilibrium water absorption rate at 80° C. and 95% RH is 3.5% or less.
(2) The semi-aromatic polyamide resin composition according to (1), wherein the toughness improver (C) is at least one selected from an olefin-based copolymer and a styrene-based elastomer.
(3) The semi-aromatic polyamide resin composition according to (2), wherein the olefin-based copolymer is at least one selected from an (ethylene and/or propylene)·α-olefin-based copolymer and an (ethylene and/or propylene)·(α, β-unsaturated carboxylic acid and/or unsaturated carboxylic acid ester)-based copolymer.
(4) The semi-aromatic polyamide resin composition according to (2) or (3), wherein the styrene-based elastomer is a styrene-ethylene-butylene-styrene block copolymer.
(5) The semi-aromatic polyamide resin composition according to any one of (1) to (4), wherein the inorganic filler (B) contains an aluminum silicate salt and a calcium silicate salt.
(6) A metal-plated molded body comprising the semi-aromatic polyamide resin composition according to any one of (1) to (5)

### Effect of the Invention

The present invention can provide a semi-aromatic polyamide resin composition having good plating properties, low water absorption properties, and solder reflow resistance, and a plated molded body containing the semi-aromatic polyamide resin composition.

### MODE FOR CARRYING OUT THE INVENTION

Hereinafter, a semi-aromatic polyamide resin composition of the present invention will be described.

A semi-aromatic polyamide resin (A) used in the present invention is not particularly limited, and is a semi-aromatic polyamide having an acid amide bond (—CONH—) in the molecule and an aromatic ring (benzene rind).

Examples of the semi-aromatic polyamide include a 6T-type polyamide (for example, polyamide 6T/61 composed of terephthalic acid/isophthalic acid/hexamethylenediamine, polyamide 6T/66 composed of terephthalic acid/adipic acid/hexamethylenediamine, polyamide 6T/61/66 composed of terephthalic acid/isophthalic acid/adipic acid/hexamethylenediamine, polyamide 6T/M-5T composed of terephthalic acid/hexamethylenediamine/2-methyl-1,5-pentamethylenediamine, polyamide 6T/6 composed of terephthalic acid/hexamethylenediamine/ε-caprolactam, polyamide 6T/4T composed of terephthalic acd/hexamethyleneidiamine/tetramethylenediamine), a 9T-type polyamide (terephthalic acid/1,9-nonanediamine/2-methyl-1,8-octanediamine), a 10 T-type polyamide (terephthalic acid/1,10-decanediamine), a 12 T-type polyamide (terephthalic acid/1,12-dodecanediamine), and a polyamide composed of sebacic acid/para-xylenediamine.

The semi-aromatic polyamide resin (A) used in the present invention needs to have a melting point (Tm) measured by differential scanning calorimetry (DSC) of 280° C. or higher. The melting point (Tm) is preferably 285° C. or higher, and more preferably 290° C. or higher. When the Tm is less than the lower limit, and a molded body containing the semi-aromatic polyamide resin composition of the present invention is processed in a solder reflow step, the molded body may be melted or deformed. The upper limit of the Tm is preferably 340° C. or lower, more preferably 330° C. or lower, and still more preferably 320° C. or lower. When the Tm exceeds the above upper limit, a processing temperature during molding processing becomes extremely high, whereby the resin may be decomposed by heat. Measurement by differential scanning calorimetry (DSC) will be described in the following section of Examples.

The semi-aromatic polyamide resin (A) used in the present invention needs to have an equilibrium water absorption rate at 80° C. and 95% RH of 3.5% or less as measured by a method described in the following section of Examples. The equilibrium water absorption rate at 80° C. and 95% RH is preferably 3.0% or less. When the equilibrium water absorption rate at 80° C. and 95% RH exceeds the above upper limit, and the molded body containing such a semi-aromatic polyamide resin composition is processed in the solder reflow step, the expansion of moisture in the molded body may cause the swelling of the surface of the molded body, and the dimensional change of the molded body may cause assembling failure.

The semi-aromatic polyamide resin (A) used in the present invention is preferably the following semi-aromatic polyamide resin from the viewpoint of the Tm and the equilibrium water absorption rate at 80° C. and 95% RH.

The semi-aromatic polyamide resin (A) is preferably a semi-aromatic polyamide resin containing 50 to 100 mol % of a repeating unit composed of a diamine having 6 to 12 carbon atoms and terephthalic acid and 0 to 50 mol % of a repeating unit composed of an aminocarboxylic acid having 10 carbon atoms or more or a lactam having 10 carbon atoms, more preferably a semi-aromatic polyamide resin containing 50 to 98 mol % of a repeating unit composed of a diamine having 6 to 12 carbon atoms and terephthalic acid and 2 to 50 mol % of a repeating unit composed of an aminocarboxylic acid having 10 carbon atoms or more or a lactam having 10 carbon atoms or more, and still more preferably a semi-aromatic polyamide resin containing 55 to 98 mol % of a repeating unit composed of a diamine having 6 to 12 carbon atoms and terephthalic acid and 2 to 45 mol % of a repeating unit composed of an aminocarboxylic acid having 10 carbon atoms or more or a lactam having 10 carbon atoms or more.

When the ratio of the repeating unit composed of a diamine having 6 to 12 carbon atoms and terephthalic acid in the semi-aromatic polyamide resin (A) is less than 50 mol %, the molded body may be melted or deformed in the solder reflow step due to a decrease in the Tm. Meanwhile, the Tm of the semi-aromatic polyamide resin (A) can be moderately improved, whereby the ratio of the repeating unit composed of a diamine having 6 to 12 carbon atoms and terephthalic acid in the semi-aromatic polyamide resin (A) is more preferably 55 mol % or more, and still more preferably 60 mol % or more.

Examples of the diamine component having 6 to 12 carbon atoms that constitutes the semi-aromatic polyamide resin (A) include 1,6-hexamethylenediamine, 1,7-heptamethylenediamine, 1,8-octamethylenediamine, 1,9-nonamethylenediamine, 2-methyl-1,8-octamethylenediamine, 1,10-decamethylenediamine, 1,11-undecamethylenediamine, and 1,12-dodecamethylenediamine. These may be used alone or in combination.

The aminocarboxylic acid having 10 carbon atoms or more or the lactam having 10 carbon atoms or more that constitutes the semi-aromatic polyamide resin (A) is preferably an aminocarboxylic acid or a lactam having 11 to 18 carbon atoms. Among them, 11-aminoundecanoic acid, undecane lactam, 12-aminododecanoic acid, and 12-lauryl lactam are preferable. From the viewpoint of the Tm and the equilibrium water absorption rate at 80° C. and 95% RH, as a copolymerization component, one or two more of an aminocarboxylic acid having 11 to 18 carbon atoms and a lactam having 11 to 18 carbon atoms are preferably copolymerized.

The semi-aromatic polyamide resin (A) used in the present invention can be copolymerized with other components in an amount of 50 mol % or less in the constituent unit. As to the copolymerizable diamine ingredient, there are exemplified an aliphatic diamine such as 1,13-tridecamethylenediamine, 1,16-hexadecamethylenediamine, 1,18-octadecamethylenedamine and 2,2,4(or 2,4,4)-trimethylhexamethylenediamine; an alicyclic diamine such as piperazine, cyclohexanediamine, bis(3-methyl-4-aminohexyl)-methane, bis(4,4′-aminocyclohexyl)methane and isophoronediamine; an aromatic diamine such as m-xylylenediamine, p-xylylenediamine, p-phenylenediamine and m-phenylenediamine; and hydrogenated products thereof.

As to the copolymerizable acid ingredient, there are exemplified an aromatic dicarboxylic acid such as isophthalic acid, orthophthalic acid, 1,5-naphthalenedicarboxylic acid, 2,6-naphthalenedicarboxylic acid, 4,4′-diphenyldicarboxylic acid, 2,2′-diphenyldicarboxylic acid, 4,4′-diphenyl ether dicarboxylic acid, 5-(sodium sulfonate)-isophthalic acid and 5-hydroxyisophthalic acid; and an aliphatic or alicyclic dicarboxylic acid such as fumaric acid, maleic acid, succinic acid, itaconic acid, adipic acid, azelaic acid, sebacic acid, 1,11-undecanedioic acid, 1,12-dodecanedioic acid, 1,14-tetradecanedioic acid, 1,18-octadecanedioic acid, 1,4-cyclohexanedicarboxylic acid, 1,3-cyclohexanedicarboxylic acid, 1,2-cyclohexanedicarboxylic acid, 4-methyl-1,2-cyclohexanedicarboxylic acid and dimer acid.

As to the copolymerizable ingredient, there are also exemplified ε-caprolactam and the like.

The aromatic polyamide resin (A) used in the present invention is preferably a semi-aromatic polyamide resin containing 50 to 100 mol % of a repeating unit composed of hexamethylenediamine and terephthalic acid and 0 to 50 mol % of a repeating unit composed of aminoundecanoic acid or undecane lactam, more preferably a semi-aromatic polyamide resin containing 50 to 98 mol % of a repeating unit composed of hexamethylenediamine and terephthalic acid and 2 to 50 mol % of a repeating unit composed of aminoundecanoic acid or undecane lactam, still more preferably a semi-aromatic polyamide resin containing 55 to 80 mol % of a repeating unit composed of hexamethylenediamine and terephthalic acid and 20 to 45 mol % of a repeating unit composed of aminoundecanoic acid or undecane lactam, and particularly preferably a semi-aromatic polyamide resin containing 60 to 70 mol % of a repeating unit composed of hexamethylenediamine and terephthalic acid and 30 to 40 mol % of a repeating unit composed of aminoundecanoic acid or undecane lactam.

When the ratio of the repeating unit composed of hexamethylenediamine and terephthalic acid in the semi-aromatic polyamide resin (A) is less than 50 mol %, the molded body may be melted or deformed in the solder reflow step due to a decrease in the Tm. Meanwhile, the ratio of the repeating unit composed of hexamethylenediamine and terephthalic acid in the semi-aromatic polyamide resin (A) is 55 to 80 mol %, whereby the crystallinity and molecular mobility of the semi-aromatic polyamide resin (A) can be controlled, and the Tm can be moderately improved, which is more preferable. The ratio of the repeating unit composed of hexamethylenediamine and terephthalic acid in the semi-aromatic polyamide resin (A) is 60 to 70 mol %, and the ratio of the repeating unit composed of aminoundecanoic acid or undecane lactam used as a copolymerization component is 30 to 40 mol %, whereby the Tm can be set in the range of 300° C. to 320° C., and not only molding processing is facilitated, but also the equilibrium water absorption rate at 80° C. and 95% RH can be set to 3.5% or less, whereby excellent solder reflow resistance can be obtained, which is more preferable.

Examples of the catalyst used for producing the semi-aromatic polyamide resin (A) include phosphoric acid, phosphorous acid, hypophosphorous acid, and a metal salt, ammonium salt and ester thereof. As to the metal for the metal salts, specific examples are potassium, sodium, magnesium, vanadium, calcium, zinc, cobalt, manganese, tin, tungsten, germanium, titanium and antimony. As to the ester, there may be used ethyl ester, isopropyl ester, butyl ester, hexyl ester, isodecyl ester, octadecyl ester, decyl ester, stearyl ester, phenyl ester, etc.

From the viewpoint of improving melt retention stability, it is preferable to add an alkali compound such as sodium hydroxide, potassium hydroxide, or magnesium hydroxide.

The relative viscosity (RV) of the semi-aromatic polyamide resin (A) measured at 20° C. in 96% concentrated sulfuric acid is preferably 0.4 to 4.0, more preferably 1.0 to 3.0, and still more preferably 1.5 to 2.5. Examples of the method for setting the relative viscosity of the polyamide within a certain range include means for adjusting a molecular weight.

The terminal carboxyl group concentration and terminal amino group concentration of the semi-aromatic polyamide resin (A) are preferably 0 to 200 eq/ton and 0 to 100 eq/ton, respectively. When the terminal carboxyl group concentration and the terminal amino group concentration exceed 200 eq/ton, gelation and deterioration may be promoted during molding processing.

With regard to the semi-aromatic polyamide resin (A), the terminal group amount and molecular weight of the polyamide can be adjusted by a method in which polycondensation is conducted by adjusting a molar ratio between an amino group amount and a carboxyl group amount or by a method in which a terminal blocking agent is added.

A stage for adding the terminal blocking agent includes a stage of charging the raw materials, an initial stage of polymerization, a latter stage of polymerization or a final stage of polymerization. As to the terminal blocking agent, although there is no particular limitation as far as it is a monofunctional compound capable of reacting with amino group or carboxyl group in the polyamide terminal, there may be used monocarboxylic acid or monoamine, acid anhydride such as phthalic anhydride, monoisocyanate, monoacid halide, monoester, monoalcohol, etc. As to the terminal blocking agent, there are exemplified an aliphatic monocarboxylic acid (such as acetic acid, propionic acid, butyric acid, valeric acid, caproic acid, caprylic acid, laurylic acid, tridecanoic acid, myristic acid, palmitic acid, stearic acid, pivalic acid and isobutyric acid), an alicyclic monocarboxylic acid (such as cyclohexanecarboxylic acid), an aromatic monocarboxylic acid (such as benzoic acid, toluic acid, α-naphthalenecarboxylic acid, β-naphthalenecarboxylic acid, methylnaphthalenecarboxylic acid and phenylacetic acid), an acid anhydride (such as maleic anhydride, phthalic anhydride and hexahydrophthalic anhydride), an aliphatic monoamine (such as methylamine, ethylamine, propylamine, butylamine, hexylamine, octylamine, decylamine, stearylamine, dimethylamine, diethylamine, dipropylamine and dibutylamine), an alicyclic monoamine (such as cyclohexylamine and dicyclohexylamine) and an aromatic monoamine (such as aniline, toluidine, diphenylamine and naphthylamine).

The semi-aromatic polyamide resin (A) can be produced by a conventionally known method. For example, the semi-aromatic polyamide resin (A) can be easily synthesized by subjecting raw material monomers to a co-condensation reaction. The order of the co-condensation polymerization reaction is not particularly limited. All the raw material monomers may be made to react at a time, or a part of the raw material monomers may be firstly made to react and then the remaining raw material monomers may be made to react. The polymerization method is not particularly limited, but steps from the charging of raw materials until the production of a polymer may be continuously carried out. Alternatively, it is also possible to use a method in which an oligomer is once produced and then polymerization is conducted in another step using an extruder or the like, or the molecular weight of the oligomer is increased by solid phase polymerization. By adjusting the charging ratio of the raw material monomers, the ratio of each structural unit in the copolymerized polyamide to be synthesized can be controlled.

The inorganic filler (B) used in the present invention is blended for improving the metal-plating adhesion, strength, and dimensional stability of the semi-aromatic polyamide resin composition, and at least one selected from a fibrous filler and a non-fibrous filler is used. Examples of the fibrous filler include glass fibers, carbon fibers, boron fibers, ceramic fibers, metal fibers, potassium titanate whiskers, aluminum borate whiskers, zinc oxide whiskers, calcium carbonate whiskers, magnesium sulfate whiskers, and fibrous wollastonite. Examples of the non-fibrous filler include an aluminum silicate salt (kaolin), a calcium silicate salt (wollastonite), a magnesium silicate salt (talc), mica, calcium carbonate, barium sulfate, glass beads, and glass balloons. The inorganic filler (B) preferably contains at least one selected from an aluminum silicate salt and a calcium silicate salt as a main component, and more preferably contains an aluminum silicate salt as a main component. The aluminum silicate salt provides also excellent appearance during molding and is not dissolved in an etching solution used in a plating step, whereby the aluminum silicate salt is likely to exhibit unevenness and has excellent plating adhesion. These inorganic fillers may be used not only singly but also in combination of several kinds.

The inorganic filler (B) is preferably subjected to an organic treatment or a coupling agent treatment in order to improve affinity with the semi-aromatic polyamide resin (A). The inorganic filler (B) is preferably used in combination with a coupling agent during melt compounding. As the coupling agent, any of a silane-based coupling agent, a titanate-based coupling agent, and an aluminum-based coupling agent may be used. Among these, an aminosilane coupling agent and an epoxysilane coupling agent are particularly preferable.

Examples of a method in which the surface of the semi-aromatic polyamide resin composition of the present invention is subjected to metal plating include a method in which an etching solution is brought into contact with the surface of a molded body molded using the semi-aromatic polyamide resin composition to perform etching (surface roughening), thereby forming an unevenness structure in the surface of the molded body, and the surface is then subjected to metal plating. Unevenness formed by etching is presumed to exhibit a mechanical bonding effect to thereby provide excellent plating adhesiveness.

The blending amount of the inorganic filler (B) used in the present invention needs to be 10 to 200 parts by mass with respect to 100 parts by mass of the semi-aromatic polyamide resin (A). The blending amount is preferably 10 to 190 parts by mass, more preferably 15 to 180 parts by mass, and still more preferably 20 to 170 parts by mass. When the blending amount of the inorganic filler (B) is less than the above lower limit, the unevenness after etching is insufficient, whereby good plating adhesiveness may not be able to be exhibited. When the blending amount of the inorganic filler (B) exceeds the above upper limit, the unevenness after etching increases, but molding processability may be deteriorated. In the semi-aromatic polyamide resin composition of the present invention, the blending amount is a content in the semi-aromatic polyamide resin composition as it is.

The toughness improver (C) used in the present invention can improve not only the toughness of the semi-aromatic polyamide resin composition but also metal plating adhesion. The toughness improver is not particularly limited as long as the toughness improver can improve the toughness of the semi-aromatic polyamide resin composition, and examples thereof include olefin-based copolymers, elastomers, synthetic rubbers, and natural rubbers.

Examples of the toughness improver (C) include olefin-based polymers such as olefin-based copolymers and ionomer-polymers, elastomers such as styrene-based elastomers, urethane-based elastomers, fluorine-based elastomers, vinyl chloride-based elastomers, polyester-based elastomers, and polyamide-based elastomers, and synthetic rubbers such as thiocol rubbers, polysulfide rubbers, acrylic rubbers, silicone rubbers, polyether rubbers, and epichlorohydrin rubber. From the viewpoint of compatibility with the semi-aromatic polyamide resin (A) and heat resistance, olefin-based polymers and elastomers are preferable, and olefin-based copolymers and styrene-based elastomers are more preferable. The olefin-based copolymer is preferably an (ethylene and/or propylene)·α-olefin-based copolymer and an (ethylene and/or propylene)·(α,β-unsaturated carboxylic acid and/or unsaturated carboxylic acid ester)-based copolymer. The styrene-based elastomer is preferably a styrene-ethylene-butylene-styrene block copolymer. These toughness improvers may be used not only singly but also in combination of several kinds. The toughness improver (C) is particularly preferably at least one of an (ethylene and/or propylene)·α-olefin-based copolymer and a styrene-ethylene-butylene-styrene block copolymer.

The (ethylene and/or propylene)·α-olefin-based copolymer used in the present invention is a polymer obtained by copolymerizing ethylene and/or propylene with an α-olefin having 4 carbon atoms or more, and examples of the α-olefin having 4 carbon atoms or more include 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, 3-methyl-1-butene, 4-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 9-methyl-1-decene, 11-methyl-1-dodecene, 12-ethyl-1-tetradecene, and combinations thereof. Polyenes of non-conjugated dienes such as 1,4-pentadiene, 1,4-hexadiene, 1,5-hexadiene, 1,4-octadiene, 1,5-octadiene, 1,6-octadiene, 1,7-octadiene, 2-methyl-1,5-hexadiene, 6-methyl-1,5-heptadiene, 7-methyl-1,6-octadiene, 4-ethylidene-8-methyl-1,7-nonadiene, 4,8-dimethyl-1,4,8-decatriene (DMDT), dicyclopentadiene, cyclohexadiene, dicyclooctadiene, methylene norbornene, 5-vinyl norbornene, 5-ethylidene-2-norbornene, 5-methylene-2-norbornene, 5-isopropylidene-2-norbornene, 6-chloromethyl-5-isopropenyl-2-norbornene, 2,3-diisopropylidene-5-norbornene, 2-ethylidene-3-isopropylidene-5-norbornene, and 2-propenyl-2,2-norbornadiene may be copolymerized.

The (ethylene and/or propylene) ·(α,β-unsaturated carboxylic acid and/or unsaturated carboxylic acid ester)-based copolymer is a polymer obtained by copolymerizing ethylene and/or propylene with an α,β-unsaturated carboxylic acid and/or an unsaturated carboxylic acid ester monomer. Examples of the α,β-unsaturated carboxylic acid monomer include acrylic acid and methacrylic acid. Examples of the α,β-unsaturated carboxylic acid ester monomer include a methyl ester, an ethyl ester, a propyl ester, a butyl ester, a pentyl ester, a hexyl ester, a heptyl ester, an octyl ester, a nonyl ester and a decyl ester of the unsaturated carboxylic acid, and mixtures thereof.

The ionomeric polymer is formed by ionization of at least a part of carboxyl groups in a copolymer of olefin and α,β-unsaturated carboxylic acid as a result of neutralization of metal ions. The olefin is preferably ethylene, and the α,β-unsaturated carboxylic acid is preferably acrylic acid or methacrylic acid. However, the α,β-unsaturated carboxylic acid is not limited to those exemplified herein, and an unsaturated carboxylic acid ester monomer may be copolymerized with the α,β-unsaturated carboxylic acid. The metal ions include alkali metals and alkaline earth metals such as Li, Na, K, Mg, Ca, Sr, and Ba. In addition to alkali metals and alkaline earth metals, the metal ions include Al, Sn, Sb, Ti, Mn, Fe, Cu, Zn, Cd, etc.

In the elastomer used in the present invention, the styrene elastomer is a block copolymer composed of an aromatic vinyl compound-based polymer block such as styrene and a conjugated diene-based polymer block. A block copolymer having at least one aromatic vinyl compound-based polymer block and at least one conjugated diene-based polymer block is used. In the block copolymer, the unsaturated bond in the conjugated diene-based polymer block may be hydrogenated.

The aromatic vinyl compound-based polymer block is a polymer block composed of structural units mainly derived from an aromatic vinyl compound. Aromatic vinyl compounds include styrene, alpha-methylstvrene, o-methylstyrene, m-methylstyrene, p-methylstyrene, 2,4-dimethylstyrene, 2,6-dimethylstyrene, vinyl naphthalene, vinyl anthracene, 4-propylstyrene, 4-cyclohexylstyrene, 4-dodecylstyrene, 2-ethyl-4-benzylstyrene, 4-(phenylbutyl)styrene, etc.

The aromatic vinyl compound-based polymer block may have a structural unit composed of one or two or more types of the monomers, or may have a structural unit composed of a small amount of other unsaturated monomer.

The conjugated diene-based polymer block is a polymer block formed from one or two more conjugated diene-based compounds such as 1,3-butadiene, chloroprene, isoprene, 2,3-dimethyl-1,3-butadiene, 1,3-pentadiene, 4-methyl-1,3-pentadiene, and 1,3-hexadiene. In the hydrogenated aromatic vinyl compound/conjugated diene block copolymer, the unsaturated bond moiety in the conjugated diene-based polymer block is partially or entirely hydrogenated to form a saturated bond. Here, the distribution in the polymer block mainly composed of a conjugated diene may be random, tapered or partially blocked, or may be any combination thereof.

The molecular structure of the aromatic vinyl compound/conjugated diene block copolymer and a hydrogenated product thereof may be linear, branched or radial, or may be any combination thereof. Among these, in the semi-aromatic polyamide resin composition of the present invention, as the aromatic vinyl compound-conjugated diene block copolymer and/or a hydrogenated product thereof, a diblock copolymer in which one aromatic vinyl compound polymer block and one conjugated diene polymer block are linearly bonded, a triblock copolymer in which three polymer blocks are linearly bonded in the order of aromatic vinyl compound polymer block-conjugated diene polymer block-aromatic vinyl compound polymer block, and a hydrogenated product thereof are preferably used individually or in combination of two or more thereof. Examples thereof include an unhydrogenated or hydrogenated styrene-butadiene copolymer, an unhydrogenated or hydrogenated styrene-isoprene copolymer, an unhydrogenated or hydrogenated styrene-isoprene-styrene copolymer, an unhydrogenated or hydrogenated styrene-butadiene-styrene copolymer, an unhydrogenated or hydrogenated styrene-isoprene-butadiene-styrene copolymer, and an unhydrogenated or hydrogenated styrene-ethylene-butadiene-styrene block copolymer.

The toughness improver (C) used in the present invention is preferably modified with a carboxylic acid and/or a derivative thereof. By the modification with such a component, a functional group having affinity with the semi-aromatic polyamide resin (A) can be introduced into the molecule, whereby compatibility with the semi-aromatic polyamide resin (A) can be improved. Examples of the functional group having affinity with the semi-aromatic polyamide resin (A) include a carboxylic acid group, a carboxylic anhydride group, a carboxylic acid ester group, a carboxylic acid metal salt group, a carboxylic acid imide group, a carboxylic acid amide group, and an epoxy group. The toughness improver (C) is particularly preferably at least one of an (ethylene and/or propylene)·α-olefin-based copolymer and a styrene-ethylene-butylene-styrene block copolymer, modified with a carboxylic acid and/or a derivative thereof.

Examples of the compound capable of improving the affinity with the semi-aromatic polvamide resin (A) include acrylic acid, methacrylic acid, maleic acid, fumaric acid, itaconic acid, crotonic acid, methyl maleic acid, methyl fumaric acid, mesaconic acid, cytraconic acid, glutaconic acid, cis-4-cyclohexene-1,2-dicarboxylic acid, endobicyclo[2.2.1]-5-heptene-2,3-dicarboxylic acid and metal salts of the carboxylic acids, monomethyl maleate, monomethyl itaconate, methyl acrylate, ethyl acrylate, butyl acrylate, 2-ethylhexyl acrylate, hydroxyethyl acrylate, methyl methacrylate, 2-ethylhexyl methacrylate, hydroxyethyl methacrylate, aminoethyl methacrylate, dimethyl maleate, dimethyl itaconate, maleic anhydride, itaconic anhydride, cytraconic anhydride, endobicyclo-[2.2.1]-5-heptene-2,3-dicarboxylic anhydride, maleimide, N-ethylmaleimide, N-butylmaleimide, N-phenylmaleimide, acrylamide, methacrylamide, glycidyl acrylate, glycidyl methacrylate, glycidyl ethacrylate, glycidyl itaconate, and glycidyl citraconate.

The blending amount of the toughness improver (C) used in the present invention needs to be 2 to 30 parts by mass with respect to 100 parts by mass of the semi-aromatic polyamide (A). The blending amount is preferably 2 to 28 parts by mass, more preferably 2 to 25 parts by mass, and still more preferably 3 to 25 parts by mass. By setting the blending amount of the toughness improver (C) within the above range, excellent metal plating adhesion can be imparted. Furthermore, high tensile elongation can be imparted, and cracking during molding and cracking during actual use can be suppressed. When the blending amount of the toughness improver (C) is less than the above lower limit, metal plating adhesion may be insufficient, and cracking during molding or cracking during actual use may occur. When the blending amount of the toughness improver (C) exceeds the above upper limit, heat resistance and deformation as the semi-aromatic polyamide resin composition are impaired, whereby the deformation of the molded body in the solder reflow step and the deformation thereof during actual use may occur. In the semi-aromatic polyamide resin composition of the present invention, the blending amount is a content in the semi-aromatic polyamide resin composition as it is.

In the semi-aromatic polyamide resin composition of the present invention, unevenness is formed in the surface of the molded body after etching by blending the semi-aromatic polyamide resin (A) with the inorganic filler (B) in a predetermined blending amount as described above, whereby metal plating adhesion can be improved by a mechanical bonding effect, but better metal plating adhesion can be exhibited by further blending the toughness improver (C). It is presumed that when the toughness improver is blended, the mechanical bonding effect due to unevenness, and the viscosity of the semi-aromatic polyamide resin composition act on the interface between the metal plating and the semi-aromatic polyamide resin composition, to exhibit excellent metal plating adhesion.

A predetermined amount of the inorganic filler (B) is blended with the semi-aromatic polyamide resin (A) as described above, and a predetermined amount of the toughness improver (C) is further blended, whereby the semi-aromatic polyamide resin composition of the present invention can exhibit high tensile elongation that is difficult to exhibit in a system in which only an inorganic filler is blended.

In the semi-aromatic polyamide resin composition of the present invention, various additives used in conventional polyamide resin compositions can be used as long as the properties of the semi-aromatic polyamide resin composition are not impaired. Examples of the additive include stabilizers, release agents, slidability improvers, coloring agents, plasticizers, crystal nucleating agents, polyamides different from the semi-aromatic polyamide resin (A), and thermoplastic resins other than polyamides. The possible blending amounts of these components in the semi-aromatic polyamide resin composition are as described below, but the total amount of these components in the semi-aromatic polyamide resin composition is preferably 30% by mass or less, more preferably 20% by mass or less, still more preferably 10% by mass or less, and particularly preferably 5% by mass or less.

Examples of the stabilizer include organic antioxidants such as hindered phenol-based antioxidants, sulfur-based antioxidants, and phosphorus-based antioxidants and heat stabilizers, hindered amine-based, benzophenone-based, and imidazole-based light stabilizers and ultraviolet absorbers, metal inactivating agents, and copper compounds. As the copper compound, copper salts of organic carboxylic acids such as cuprous chloride, cuprous bromide, cuprous iodide, cupric chloride, cupric bromide, cupric iodide, cupric phosphate, cupric pyrophosphate, copper sulfide, copper nitrate, and copper acetate can be used. Furthermore, as a constituent component other than the copper compound, it is preferable to contain an alkali metal halide compound. Examples of the alkali metal halide compound include lithium chloride, lithium bromide, lithium iodide, sodium fluoride, sodium chloride, sodium bromide, sodium iodide, potassium fluoride, potassium chloride, potassium bromide, and potassium iodide. These additives may be used not only singly but also in combination of several kinds. The optimum added amount of the stabilizer may be selected, but it is possible to add at most 5 parts by mass of the stabilizer to 100 parts by mass of the semi-aromatic polyamide resin (A).

Examples of the release agent include a long-chain fatty acid or an ester and metal salt thereof, an amide-based compound, polyethylene wax, silicone, and polyethylene oxide. The long-chain fatty acid is particularly preferably one having 12 carbon atoms or more, and examples thereof include stearic acid, 12-hydroxystearic acid, behenic acid, and montanic acid. These may be esterified with monoglycol or polyglycol or may form a metal salt partially or entirely at all carboxylic acids. Examples of the amide-based compound include ethylene bisterephthalamide and methylene bisstearylamide. These release agents may be used alone or as a mixture. The optimum added amount of the release agent may be selected, but it is possible to add at most 5 parts by mass of the release agent to 100 parts by mass of the semi-aromatic polyamide resin (A).

In the semi-aromatic polyamide resin composition of the present invention, a polyamide having a composition different from that of the semi-aromatic polyamide resin (A) may be subjected to polymer blending. The optimum added amount of the polyamide having a composition different from that of the semi-aromatic polyamide resin (A) may be selected, but it is possible to add at most 50 parts by mass of the polyamide to 100 parts by mass of the semi-aromatic polyamide resin (A).

Thermoplastic resins other than the polyamide may be added to the semi-aromatic polyamide resin composition of the present invention. Polymers other than polyamide include polyphenylene sulfide (PPS), liquid crystal polymer (LCP), aramid resin, polyether ether ketone (PEEK), polyether ketone (PEK), polyetherimide (PEI), Thermoplastic Polyimide, Polyamideimide (PAI), Polyetherketone Ketone (PEKK), polyphenylene ether (PPE), polyethersulfone (PES), polysulfone (PSU), polyarylate (PAR) Polyethylene terephthalate, polybutylene terephthalate, polyethylene naphthalate, polybutylene naphthalate, polycarbonate (PC), Polyoxymethylene (POM), Polypropylene (PP), Polyethylene (PE), Polymethylpentene (TPX), Polystyrene (PS), Polymethylmethacrylate, acrylonitrile-styrene copolymer (AS) and acrylonitrile-butadiene-styrene copolymer (ABS).

These thermoplastic resins can be blended in a molten state by melt-kneading, but the thermoplastic resins may be made fibrous or particulate and dispersed in the polyamide resin composition of the present invention. The optimum added amount of the thermoplastic resin may be selected, but it is possible to add at most 50 parts by mass of the thermoplastic resin to 100 parts by mass of the semi-aromatic polyamide resin (A).

When a thermoplastic resin other than the aromatic polyamide resin (A) is added to the semi-aromatic polyamide resin composition of the present invention, a reactive group capable of reacting with the polyamide is preferably copolymerized. The reactive group is a group capable of reacting with an amino group, a carboxyl group, and a main chain amide group which are terminal groups of the polyamide resin. Specific examples thereof include a carboxylic acid group, an acid anhydride group, an epoxy group, an oxazoline group, an amino group, and an isocyanate group, and among these, an acid anhydride group is most excellent in reactivity.

The semi-aromatic polyamide resin composition of the present invention can be produced by blending the above-described constituent components by a conventionally known method. Examples thereof include a method in which components are added during the polycondensation reaction of the semi-aromatic polyamide resin (A), a method in which the semi-aromatic polyamide resin (A) and other components are dry-blended, and a method in which constituent components are melt-kneaded using a twin-screw type extruder.

The semi-aromatic polyamide resin composition of the present invention can be molded into a molded body by a known molding method such as injection molding. When the molded body is produced using the semi-aromatic polyamide resin composition of the present invention, a mold temperature in injection molding is preferably 180° C. or lower, more preferably 170° C. or lower, still more preferably 160° C. or lower, and particularly preferably 150° C. or lower. When the mold temperature exceeds the above upper limit, molding defects such as remaining of the molded body in a mold may occur. The lower limit of the mold temperature is not particularly limited, but is preferably 50° C. or higher, more preferably 70° C. or higher, still more preferably 100° C. or higher, and particularly preferably 120° C. or higher from the viewpoint of the fluidity of the resin, the appearance of the molded body, and the suppression of dimensional change in an actual use environment.

The semi-aromatic polyamide resin composition of the present invention can be used as a metal-plated molded body obtained by subjecting the surface of a molded body obtained using the semi-aromatic polyamide resin composition to metal plating. The metal-plated molded body has more excellent metal-plating adhesion, low water absorption properties, and solder reflow resistance than those of a conventional metal-plated molded body.

A method for producing the metal-plated molded body using the semi-aromatic polyamide resin composition of the present invention is not particularly limited, and the metal-plated molded body can be produced by a known technique. Examples thereof include a catalyst accelerator method in which a surface is roughened by a chemical etching treatment using chromic acid, permanganic acid, or hydrochloric acid or the like, and then steps such as neutralization, catalyst application, activation, electroless plating, acid activation, and electroplating are sequentially performed using the roughened surface, a metal plating method according to a direct plating method in which the electroless plating step in the catalyst accelerator method is omitted, and the like, a catalyst accelerator method in which a surface is modified by ultraviolet rays or laser light having a specific wavelength, and then steps such as catalyst application, activation, electroless plating, acid activation, and electroplating are sequentially performed using the modified surface, and a metal plating method according to a direct plating method in which the electroless plating step in the catalyst accelerator method is omitted, and the like. The entire surface of the molded body for plating or a part thereof can be subjected to etching and metal plating.

The optimum metal plating thickness of the metal-plated molded body using the semi-aromatic polyamide resin composition of the present invention may be selected, but is preferably 0.5 to 200 μm, and more preferably 1 to 150 μm.

The metal-plated molded body using the semi-aromatic polyamide resin composition of the present invention has excellent metal adhesion due to the inorganic filler and the toughness improver blended in the semi-aromatic polyamide resin composition.

The metal plating peel strength of the metal-plated molded body using the semi-aromatic polyamide resin composition of the present invention is measured by a method described in the section of Examples below. The metal plating peel strength is an item related to good plating properties of the semi-aromatic polyamide resin composition of the present invention. The metal plating peel strength needs to be 4.0 N/cm or more, and is preferably 5.0 N/cm or more. In order to suppress the occurrence of adhesion defects such as floating and peeling of metal plating in the use environment, it is advantageous to have higher metal plating peel strength. The metal plating peel strength is more preferably 6.0 N/cm or more. In the present invention, the metal plating peel strength can be achieved. The metal plating peel strength is more preferably 6.5 N/cm or more. When the metal plating peel strength is less than the above lower limit, the adhesion between the semi-aromatic polyamide resin composition and the metal plating is low, whereby the floating or peeling of the metal plating may occur.

The tensile elongation of the metal-plated molded. body using the semi-aromatic polyamide resin composition of the present invention is measured by a method described in the section of Examples below. The tensile elongation is an item related to the molding processability of the semi-aromatic polyamide resin composition of the present invention and the durability of a product upon actual use. The tensile elongation needs to be 1.5% or more, and is preferably 1.7% or more. When the tensile elongation is less than the above lower limit, cracking during molding or cracking during actual use may occur.

The metal-plated molded body using the semi-aromatic polyamide resin composition of the present invention can be used for various applications such as automobile parts, electrical and electronic parts, CA equipment parts, and electromagnetic wave shielding parts by taking advantage of good metal plating adhesion of the metal-plated molded body.

### EXAMPLES

Hereinafter, the present invention will be more specifically described with reference to Examples, but the present invention is not limited thereto. Measured values disclosed in Examples are values measured by the following methods.

### (1) Terminal Amino Group Concentration (AEG), Terminal Carboxyl Group Concentration (CEG)

A semi-aromatic polyamide resin (A) was dissolved in a solvent of deuterated chloroform (CDCl₃)/hexafluoroisopropanol (HFIP)=1/1 (volume ratio). Deuterated formic acid was added dropwise thereto, and each terminal group concentration was then measured by ¹H-NMR.

### (2) Relative Viscosity (RV)

In 25 ml of 96% sulfuric acid, 0.25 g of a semi-aromatic polyamide resin was dissolved, and relative viscosity thereof was measured at 20° C. using an Ostwald viscometer.

### (3) Melting Point (Tm)

10 mg of a semi-aromatic polyamide resin dried under reduced pressure at 105° C. for 15 hours was weighed in an aluminum pan (product number: 170421S, manufactured by SII NanoTechnology Inc.), and sealed with an aluminum lid (Product number 170420, manufactured by SII NanoTechnology Inc.) to prepare a measurement sample. Then, the temperature was raised from room temperature at 20° C./min using a high sensitivity type differential scanning calorimeter DSC7020 (manufactured by SII NanoTechnology Inc.), and held at 350° C. for 3 minutes. Then, the measurement sample pan was taken out, and immersed in liquid nitrogen to be rapidly cooled. Thereafter, the sample was taken out from the liquid nitrogen, and allowed to stand at room temperature for 30 minutes. Then, the temperature was raised again from room temperature at 20° C./min using a high sensitivity type differential scanning calorimeter DSC7020 (manufactured by SII NanoTechnology Inc.), and held at 350° C. for 3 minutes. The peak temperature of endotherm due to melting during temperature rising was taken as a melting point (Tm).

### (4) Equilibrium Water Absorption Rate at 80° C. and 95% RH

Using an injection molding machine EC-100 manufactured by Toshiba Machine Co., Ltd., a flat plate having a length of 100 mm, a width of 100 mm, and a thickness of 1 mm was prepared as a test piece for evaluation by injection molding with a cylinder temperature set to the melting point of a resin+20° C. and a mold temperature set to 140° C. This test piece was subjected to an annealing treatment in an atmosphere at 150° C. for 2 hours, and then the mass thereof was measured. The mass at this time was taken as a mass upon drying. Furthermore, the annealed test piece was allowed to stand in an atmosphere of 85° C. and 95% RH (relative humidity) for 1000 hours, and then the mass thereof was measured. The mass at this time was taken as a mass upon saturated water absorption. An equilibrium water absorption rate at 80° C. and 95% RH was determined according to the following formula from the masses upon saturated water absorption and upon drying measured by the above-described method.

Equilibrium water absorption rate (%) at 80° C. and 95% RH={(mass upon saturated water absorption−mass upon drying)/mass upon drying}×100

### (5) Tensile Elongation

Using an injection molding machine EC-100 manufactured by Toshiba Machine Co., Ltd., a multipurpose test piece (ISO3167) was prepared in accordance with ISO 294-1 with a cylinder temperature set to the melting point of a resin+20° C. and a mold temperature set to 140° C. The tensile elongation of the prepared test piece was evaluated in accordance with ISO 527-1,2.

### (6) Metal Plating Peel Strength

Using an injection molding machine EC-100 manufactured by Toshiba Machine Co., Ltd., a flat plate having a length of 100 mm, a width of 100 mm, and a thickness of 2 mm was prepared as a test piece for evaluation by injection molding with a cylinder temperature set to the melting point of a resin+20° C. and a mold temperature set to 140° C. The obtained test piece was wiped with isopropyl alcohol, and then subjected to a degreasing treatment at 60° C. for 3 minutes using 50 g/l OPC-250 Cleaner (manufactured by OKUNO SEIYAKU KK). Thereafter, the test piece was immersed in a chromic acid solution composed of 400 g/l of chromic acid, 200 ml/l of concentrated sulfuric acid, and 0.3 g/l of Top Shut (manufactured by OKUNO SEIYAKU KK) at 70° C. for 5 minutes to perform a surface treatment. The surface-treated test piece was acid-washed with a 5% aqueous solution of 38% hydrochloric acid at room temperature for 3 minutes, and then immersed in a treatment liquid composed of 200 ml/l of B-200 Neutrizer (manufactured by OKUNO SEIYAKU KK) adjusted to 45° C. for 5 minutes. Next, the test piece was immersed in a treatment liquid composed of a tin-palladium complex salt aqueous solution (A30 Catalyst, manufactured by OKUNO SEIYAKU KK) adjusted to 25° C., hydrochloric acid, and water (volume ratio=1:1:5) for 4 minutes (catalysting). Thereafter, the test piece was immersed in a 10% aqueous solution of 38% hydrochloric acid adjusted to 50° C. for 4 minutes (accelerating), and then immersed in an electroless nickel plating solution composed of TMP chemical nickel A and B solutions adjusted to 40° C. (manufactured by CKUNC SEIYAKU KK), and water (volume ratio=1:1:4) for 10 minutes to form a nickel plating layer of about 1 pm on the surface of the test piece. The test piece was further subjected to electrolytic copper plating to form a copper plating layer. A strip test piece having a length of 100 mm, a width of 10 mm, and a thickness of 2 mm was cut out from the obtained metal-plated test piece to obtain a test piece for evaluation of peel strength. Using the prepared test piece for evaluation of peel strength, metal plating peel strength was measured in accordance with a 90 degree peel strength test method in JIS H8630.

### (7) Metal-Plated Appearance

Using an injection molding machine EC-100 manufactured by Toshiba Machine Co., Ltd., a flat plate having a length of 100 mm, a width of 100 mm, and a thickness of 2 mm was prepared as a test piece for evaluation by injection molding with a cylinder temperature set to the melting point of a resin+20° C. and a mold temperature set to 140° C. The obtained test piece was wiped with isopropyl alcohol, and then subjected to a degreasing treatment at 60° C. for 3 minutes using 50 g/l GPC-250 Cleaner (manufactured by OKUNO SEIYAKU KK). Thereafter, the test piece was immersed in a chromic acid solution composed of 400 g/l of chromic acid, 200 ml/l of concentrated sulfuric acid, and 0.3 g/l of Top Shut (manufactured by OKUNO SEIYAKU KK) at 70° C. for 5 minutes to perform a surface treatment. The surface-treated test piece was acid-washed with a 5% aqueous solution of 38% hydrochloric acid at room temperature for 3 minutes, and then immersed in a treatment liquid composed of 200 ml/l of B-200 Neutrizer (manufactured by OKUNO SEIYAKU KK) adjusted to 45° C. for 5 minutes. Next, the test piece was immersed in a treatment liquid composed of a tin-palladium complex salt aqueous solution (A30 Catalyst, manufactured by OKUNO SEIYAKU KK) adjusted to 25° C., hydrochloric acid, and water (volume ratio=1:1:5) for 4 minutes (catalysting). Thereafter, the test piece was immersed in a 10% aqueous solution of 38% hydrochloric acid adjusted to 50° C. for 4 minutes (accelerating), and then immersed in an electroless nickel plating solution composed of TMP chemical nickel A and B solutions adjusted to 40° C. (manufactured by OKUNO SEIYAKU KK), and water (volume ratio=1:1:4) for 10 minutes to form a nickel plating layer of about 1 μm on the surface of the test piece. The test piece was further subjected to electrolytic copper plating to form a copper plating layer. The appearance of the obtained metal-plated test piece was observed, and the appearance was evaluated by the presence or absence of floating of the metal plating.

Good: No floating of metal plating

Poor: Floating of metal plating

### (8) Solder Reflow Resistance

Using an injection molding machine EC-100 manufactured by Toshiba Machine Co., Ltd., a test piece for UL combustion test having a length of 127 mm, a width of 12.6 mm, and a thickness of 0.8 mm was prepared by injection molding with a cylinder temperature set to the melting point of a resin+20° C. and a mold temperature set to 140° C. The test piece was allowed to stand in an atmosphere of 85° C. and 85% RH (relative humidity) for 72 hours. The test piece was subjected to preliminary heating in an air reflow furnace (AIS-20-820 manufactured by Eightech) by raising the temperature from room temperature to 150° C. over 60 seconds, and then preheated to 190° C. at the temperature raising rate of 0.5° C./min. Thereafter, the temperature was raised to a predetermined set temperature at the rate of 100° C./min, and held at the predetermined temperature for 10 seconds, followed by cooling. The set temperature was raised every 5° C. starting from 240° C. The highest set temperature at which no swelling or deformation of the surface of the test piece occurred was taken as a reflow heat resistance temperature, and used as an index of solder heat resistance.

Good: Reflow heat resistance temperature of 260° C. or higher

Poor: Reflow heat resistance temperature of lower than 260° C.

In the present Examples, semi-aromatic polyamide resin (A) synthesized by the following method or as commercially available products were used. The physical properties of each semi-aromatic polyamide resin (A) are shown in Table 1.

TABLE 1

| | | Semi-Aromatic | |
|---|---|---|---|
| | | Polyamide Resin | |
| | | A1 | A2 |
| constituent | terephthalic acid (mol %) | 65.1 | 100.0 |
| monomer | 1,6 hexamethylenediamine | 65.1 | |
| | (mol %) | | |
| | 11-aminoundecanoic acid | 34.9 | |
| | (mol %) | | |
| | 1,9-nonanediamine (mol %) | | 85.2 |
| | 2-methyl-1,8- | | 14.8 |
| | octanediamine (mol %) | | |

| | | |
|---|---|---|
| Relative Viscosity (RV) | 2.1 | 2.1 |
| Melting Point (Tm) (°C) | 314 | 286 |
| Terminal Amino Group Concentration | 30 | 13 |
| (AEG) (eq/ton) | | |
| Terminal Carboxyl Group Concentration | 140 | 50 |
| (CEG) (eq/ton) | | |

### Synthesis Example 1; Semi-Aromatic Polyamide Resin (A1)

8.55 kg of 1,6 hexamethylenediamine, 12.25 kg of terephthalic acid, 8.00 kg of 11-aminoundecanoic acid, 9 g of sodium hypophosphite as a catalyst, 140 g of acetic acid as a terminal adjusting agent, and 16.20 kg of ion-exchanged water were charged into a 50-liter autoclave, and pressurized with N₂ from normal pressure to 0.05 MPa. The pressure was released to return to the normal pressure. This operation was performed 3 times to perform substitution with N₂, and the content of the autoclave was then uniformly dissolved at 135° C. and 0.3 MPa under stirring.

Thereafter, the dissolved solution was continuously supplied by a liquid feeding pump, heated to 240° C. by a heating pipe, and heated for 1 hour. Thereafter, the reaction mixture was supplied to a pressurizing reaction container, and heated to 290° C. A part of water was distilled out so as to maintain the internal pressure of the container at 3 MPa, to obtain a low-order condensed product. Thereafter, this low-order condensed product was directly supplied to a biaxial extruder (screw diameter: 37 mm; L/D=60) while the melted state was maintained, and polycondensation was conducted under the melted state at a resin temperature of 335° C. while water was discharged from three vents to obtain a semi-aromatic polyamide resin (A1). The obtained semi-aromatic polyamide resin (A1) was composed of 65.1 mol % of a structural unit composed of 1,6 hexamethylenediamine and terephthalic acid and 34.9 mol % of a structural unit composed of 11-aminoundecanoic acid, and had a relative viscosity of 2.1, a melting point of 314° C., AEG 30 eq/ton, and CEG 140 eq/ton. The constituent monomer ratio of the polyamide resin was confirmed by ¹H-NMR as in AEG and CEG measurements.

### Synthesis Example 2; Semi-Aromatic Polyamide Resin (A2)

A semi-aromatic polyamide resin composed of a terephthalic acid unit, a 1,9-nonanediamine unit, and a 2-methyl-1,8-octanediamine unit (the molar ratio of the 1,9-nonanediamine unit to the 2-methyl -1,8-octanediamine unit was 85:15) was synthesized according to a method described in Example 1 of JP-A-7-228689 (benzoic acid was used as an endcapping agent). The obtained semi-aromatic polyamide resin (A2) was composed of 85.2 mol % of a structural unit composed of 1,9-nonanediamine and terephthalic acid and 14.8 mol % of a structural unit composed of 2-methyl-1,8-octanediamine and terephthalic acid, and had a relative viscosity of 2.1, a melting point of 286° C., AEG 13 eq/ton, and CRG 50 eq/ton. The constituent monomer ratio of the polyamide resin was confirmed by ¹H-NMR as in AEG and CEG measurements.

In the present Examples, semi-aromatic polyamide resin compositions prepared as exemplified below were used.

Polvamide raw materials were melt-kneaded at mass ratios (parts by mass) described in Table 2 and Table 3 at the melting point of each polyamide raw material+20° C. using a twin screw extruder STS-35 manufactured by Coperion Corporation to obtain semi-aromatic polyamide resin compositions of Examples 1 to 11 and Comparative Examples 1 to 5. The raw materials used in the production of the semi-aromatic polyamide resin composition are as follows. A release agent and a stabilizer used as other additives were used at the mass ratio of 1:5.

Semi-aromatic polyamide resin (A1):Semi-aromatic polyamide resin produced based on Synthesis Example 1 above Semi-aromatic polyamide resin (A2):Semi-aromatic polyamide resin produced based on Synthesis Example 2 above Semi-aromatic polyamide resin (A3):PA6T/6 (Ultramide (R) KR4351 manufactured by BASF AG, Tm=290° C.)

Inorganic filler (B1): Calcined kaolin (Translink (R) 445 manufactured by BASF AG, surface-treated, average particle diameter: 1.4 μm)
Inorganic filler (52): Calcined kaolin (Satintone (R) 5HB manufactured by BASF AG, not surface-treated, average particle diameter: 0.8 μm)
Inorganic filler (B3): Fibrous wollastonite (NYGLOS (R) 8 manufactured by NYCO Corporation, surface-treated)
Toughness improver (C1): Maleic anhydride-modified styrene-ethylene-butylene-styrene block copolymer (Tuftec (R) M1943, manufactured by Asahi Kasei Corporation)
Toughness improver (C2): Maleic anhydride-modified ethylene-butene copolymer (TAFMER (R) MH7020 manufactured by Mitsui Chemicals, Inc.)
Toughness improver (C3): Maleic anhydride-modified propylene-butene copolymer (TAFMER (R) MP0620 manufactured by Mitsui Chemicals, Inc.)
Toughness improver (C4): Ethylene-acrylic acid ester-maleic anhydride copolymer (Bondine (R) AX-8390 manufactured by Arkema, Inc.)
Release agent: Magnesium stearate
Stabilizer: Pentaerythrityl tetrakis[3-(3,5-di-t-butyl-4-hydroxyphenyl)propionate] (Irganox 1010 manufactured by Chiba Speciality Chemicals Inc.)

TABLE 2

| | | | | | | | | | Exam- | Exam- | Exam- | Exam- | Exam- |
|---|---|---|---|---|---|---|---|---|---|---|---|---|---|
| | | | Example1 | Example2 | Example3 | Example4 | Example5 | Example6 | ple7 | ple8 | ple9 | ple10 | ple11 |
| Composition | A1 | parts | 100 | 100 | 100 | 100 | 100 | 100 | 100 | 100 | 100 | 100 | |
| | | by mass | | | | | | | | | | | |
| | A2 | parts | | | | | | | | | | | 100 |
| | | by mass | | | | | | | | | | | |
| | B1 | parts | 73 | 27 | 165 | 70 | 82 | 73 | 73 | 73 | | | 7 3 |
| | | by mass | | | | | | | | | | | |
| | B2 | parts | | | | | | | | | 73 | | |
| | | by mass | | | | | | | | | | | |
| | B3 | parts | | | | | | | | | | 73 | |
| | | by mass | | | | | | | | | | | |
| | C1 | parts | 9 | 9 | 10 | 5 | 22 | | | | 9 | 9 | 9 |
| | | by mass | | | | | | | | | | | |
| | C2 | parts | | | | | | 9 | | | | | |
| | | by mass | | | | | | | | | | | |
| | C3 | parts | | | | | | | 9 | | | | |
| | | by mass | | | | | | | | | | | |
| | C4 | parts | | | | | | | | 9 | | | |
| | | by mass | | | | | | | | | | | |
| | Other | parts | 1 | 1 | 1 | 1 | 1 | 1 | 1 | 1 | 1 | 1 | 1 |
| | | by mass | | | | | | | | | | | |

Semi-Aromatic Polyamide Resin (A)

| | | | | | | | | | | | |
|---|---|---|---|---|---|---|---|---|---|---|---|
| Melting Point (Tm) (° C.) | 314 | 314 | 314 | 314 | 314 | 314 | 314 | 314 | 314 | 314 | 286 |
| Equilibrium Water Absorption | 3.0 | 3.0 | 3.0 | 3.0 | 3.0 | 3.0 | 3.0 | 3.0 | 3.0 | 3.0 | 2.4 |
| Rate at 80° C. and 95% RH (%) | | | | | | | | | | | |

Semi-Aromatic Polyamide Resin Composition

| | | | | | | | | | | | |
|---|---|---|---|---|---|---|---|---|---|---|---|
| Tensile Elongation (%) | 2.4 | 3.2 | 1.7 | 2.0 | 5.0 | 2.5 | 2.2 | 2.3 | 2.6 | 2.3 | 2.3 |
| Metal Plating Peel Strength | 8.1 | 7.2 | 9.0 | 6.6 | 8.9 | 6.7 | 9. 2 | 6.3 | 7.5 | 6.2 | 6.3 |
| (N/cm) | | | | | | | | | | | |
| Metal-Plated Appearance | Good | Good | Good | Good | Good | Good | Good | Good | Good | Good | Good |
| Solder Reflow Resistance | Good | Good | Good | Good | Good | Good | Good | Good | Good | Good | Good |

TABLE 3

| | | | Comparative | Comparetive | Comparative | Comparative | Comparative |
|---|---|---|---|---|---|---|---|
| | | | Example1 | Example2 | Example3 | Example4 | Example5 |
| Composition | A1 | parts | 100 | 100 | 100 | | |
| | | by | | | | | |
| | | mass | | | | | |
| | A2 | parts | | | | 100 | |
| | | by | | | | | |
| | | mass | | | | | |
| | A3 | parts | | | | | 100 |
| | | by | | | | | |
| | | mass | | | | | |
| | B1 | parts | 67 | | | 67 | 67 |
| | | mass | | | | | |
| | B3 | parts | | 67 | | | |
| | | by | | | | | |
| | | mass | | | | | |
| | C1 | parts | | | 9 | | |
| | | by | | | | | |
| | | mass | | | | | |
| | Other | parts | 1 | 1 | 1 | 1 | 1 |
| | | by | | | | | |
| | | mass | | | | | |

Semi-Aromatic Polyamide Resin (A)

| | | | | | |
|---|---|---|---|---|---|
| Melting Point (Tm) (° C.) | 314 | 314 | 314 | 286 | 290 |
| Equilibrium Water Absorption | 3.0 | 3.0 | 3.0 | 2.4 | 4.5 |
| Rate at 80° C. and 95% RH (%) | | | | | |

Semi-Aromatic Polyamide Resin Composition

| | | | | | |
|---|---|---|---|---|---|
| Tensile Elongation (%) | 1.2 | 1.1 | 5.0 | 1.2 | 1.3 |
| Metal Plating Peel Strength | 5.8 | 3.8 | 0.0 | 4.5 | 5.0 |
| (N/cm) | | | | | |
| Metal-Plated Appearance | Good | Good | Poor | Good | Good |
| Solder Reflow Resistance | Good | Good | Good | Good | Poor |

### Examples 1 to 11 and Comparative Examples 1 to 5

As is apparent from Table 2, Examples 1 to 11 are found to exhibit excellent tensile elongation, metal plating peel strength, and metal plating appearance, also have reflow solder resistance, and have excellent properties. Furthermore, Examples 1 to 7 and 9 are found to exhibit particularly excellent metal plating peel strength and have excellent properties. Meanwhile, from Table 3, in Comparative Examples 1 and 2, the metal plating appearance and the reflow solder resistance are good, but the toughness improver (C) is not blended, whereby the tensile elongation is low, and the metal plating peel strength is also lower than that in Examples, which is insufficient to suppress poor plating adhesion in the use environment. In Comparative Example 3, the tensile elongation and the reflow solder resistance are good, but the inorganic filler (B) is not blended, whereby the metal plating peel strength and the metal plating appearance are poor. In Comparative Example 4, a semi-aromatic polyamide (PA9T/M8T) different from that in Examples 1 to 10 is used, and the reflow solder resistance is good, but the tensile elongation is low, and the metal plating peel strength is also lower than that in Examples, which is insufficient to suppress poor plating adhesion in the use environment. In Comparative Example 5, a semi-aromatic polyamide (PA6T/6) different from that in Examples 1 to 11 is used, and the tensile elongation is low. The metal plating peel strength is also lower than that in Examples, which is insufficient to suppress poor plating adhesion in the use environment. In addition, the saturated water absorption rate at 80° C. and 95% RH is high, whereby the reflow solder resistance is poor.

### INDUSTRIAL APPLICABILITY

The inorganic filler and the toughness improver are blended with the composition of the semi-aromatic polyamide resin, whereby the semi-aromatic polyamide resin composition of the present invention can exhibit good metal plating adhesion and plating appearance and also satisfy solder reflow resistance, and the molded body requiring metal plating can be industrially advantageously produced.

1. A semi-aromatic polyamide resin composition comprising: 10 to 200 parts by mass of an inorganic filler (B) and 2 to 30 parts by mass of a toughness improver (C) based on 100 parts by mass of a semi-aromatic polyamide resin (A), wherein the semi-aromatic polyamide resin (A) satisfies the following (a) and (b):
(a) a melting point (Tm) measured by differential scanning calorimetry (DSC) is 280° C. or higher; and
(b) an equilibrium water absorption rate at 80° C. and 95% RH is 3.5% or less.

2. The semi-aromatic polyamide resin composition according to claim 1, wherein the toughness improver (C) is at least one selected from an olefin-based copolymer and a styrene-based elastomer.

3. The semi-aromatic polyamide resin composition according to claim 2, wherein the olefin-based copolymer is at least one selected from an (ethylene and/or propylene)·α-olefin-based copolymer and an (ethylene and/or propylene)·(α,β-unsaturated carboxylic acid and/or unsaturated carboxylic acid ester)-based copolymer.

4. The semi-aromatic polyamide resin composition according to claim 2, wherein the styrene-based elastomer is a styrene-ethylene-butylene-styrene block copolymer.

5. The semi-aromatic polyamide resin composition according to claim 1, wherein the inorganic filler (B) contains an aluminum silicate salt and a calcium silicate salt.

6. A metal-plated molded body comprising the semi-aromatic polyamide resin composition according to claim 1.
